(19) United States
(12) Patent Application Publication
(10) Pub. No.: US 2026/0221636 A1
(43) Pub. Date: Jul. 30, 2026

(54) SEALING VALVE APPARATUS FOR SECONDARY BATTERY FILLING PORT

(71) Applicant: SK On Co., Ltd., Seoul (KR)

(72) Inventors: Seung Hyeon CHEON, Daejeon (KR); Jae Sung BAE, Daejeon (KR); Ji Hyeon KIM, Daejeon (KR)

(21) Appl. No.: 19/455,831

(22) Filed: Jan. 22, 2026

(30) Foreign Application Priority Data
Jan. 24, 2025 (KR) 10-2025-0011547
May 2, 2025 (KR) 10-2025-0058527

(51) Int. Cl. H01M 50/636; H01M 50/618

(52) U.S. Cl. CPC H01M 50/636; H01M 50/618

(57) ABSTRACT

Proposed is a sealing valve apparatus for a secondary battery filling port, the apparatus including a fluid valve part having a first side connected to an electrolyte filling port of a secondary battery and a second side connected to secondary battery manufacturing equipment, in which an electrolyte filling flow path is formed therein to provide communication between the first and second sides, and which opens the flow path by externally supplied pressure to connect the filling port and the secondary battery manufacturing equipment so as to be in fluid communication with each other. According to the apparatus, the filling port of is kept sealed under normal conditions to prevent the entry of moisture or foreign substances, and is automatically opened only when necessary, thereby reducing maintenance and management costs associated with sealing the filling port during the manufacturing process of a secondary battery, simplifying the process, and enhancing productivity.

### CROSS REFERENCE TO RELATED APPLICATION

The present application claims priority to Korean Patent Application No. 10-2025-0058527, filed May 2, 2025, which claims priority to Korean Patent Application No. 10-2025-0011547, filed Jan. 24, 2025, the entire contents of which is incorporated herein for all purposes by this reference.

### BACKGROUND

### Technical Field

The present disclosure relates to a sealing valve apparatus for a secondary battery filling port.

### Description of the Related Art

Secondary batteries are energy storage devices that store and supply electrical energy, and are essentially utilized in various industries including electric vehicles, energy storage systems (ESS), and portable electronic devices. During the manufacturing process of secondary batteries, an electrolyte injection (electrolyte filling) process and a heated vacuum pre-charging (HVPC) process may be among the important processes that determine the performance and lifespan of a battery.

After assembly is completed, the process involves injecting an electrolyte into the cell. Electrolyte injection (or filling) is typically performed by injecting the electrolyte under a vacuum environment, thereby minimizing internal air bubbles and increasing the penetration rate of the electrolyte.

In addition, during the manufacturing process of a secondary battery, a HVPC process may be performed to optimize battery performance. In the HVPC process, gas inside the cell is removed under a vacuum condition, and heat is applied so that the electrolyte is uniformly impregnated into the electrodes, while simultaneously performing an initial charging (pre-charge).

For these processes to be effectively performed, a process of precisely establishing a fluid communication between the secondary battery manufacturing equipment and the interior of a secondary battery cell through an electrolyte filling port is required. In addition, under normal conditions, it is important to prevent foreign substances or moisture from entering the interior of the cell through the electrolyte filling port from the outside.

Accordingly, the electrolyte filling port should be kept closed under normal conditions to prevent foreign substances or moisture from entering the interior of the cell, and should be opened during the electrolyte injection process or the HVPC process. Such opening, closing, and sealing of the electrolyte filling port are typically performed through separate cumbersome manual operations or semi-automatic methods, but there has been an increasing demand for automation.

### SUMMARY

According to an aspect of the present disclosure, there is provided a sealing valve apparatus for a secondary battery filling port, which keeps the electrolyte filling port sealed under normal conditions and automatically opens the electrolyte filling port only when opening of the electrolyte filling port is required.

According to another aspect of the present disclosure, there is provided a sealing valve apparatus for a secondary battery filling port, which can be widely applied in green technology fields such as electric vehicles, battery charging stations, and other battery-based applications including solar power generation and wind power generation.

A sealing valve apparatus for a secondary battery filling port according to an embodiment of the present disclosure may include: a fluid valve part having a first side connected to an electrolyte filling port of a secondary battery and a second side connected to secondary battery manufacturing equipment, in which an electrolyte filling flow path is formed therein to provide communication between the first side and the second side, and configured to open the electrolyte filling flow path by externally supplied pressure to connect the electrolyte filling port and the secondary battery manufacturing equipment so as to be in fluid communication with each other.

In this case, the fluid valve part may include: a body part in which the electrolyte filling flow path is formed; a first port provided at a first side of the electrolyte filling flow path so as to be connectable to the electrolyte filling port; a second port provided at a second side of the electrolyte filling flow path so as to be connectable to the secondary battery manufacturing equipment; and an on/off valve movably provided within the body part to selectively open and close the electrolyte filling flow path.

In addition, the fluid valve part may further include: a piston part connected to the on/off valve and configured to actuate the on/off valve by moving under pressure; and a pressure applying part provided in the body part to provide pressure to the piston part.

In this case, the apparatus may further include a first connection part having a first side connected to the first port and a second side provided to be in contact with the electrolyte filling port.

In addition, the first connection part may include: a body; a nozzle provided on the body to be movable in a direction of the electrolyte filling port so that a distal end of the nozzle comes into close contact with the electrolyte filling port; and an elastic member configured to provide an elastic force to press the nozzle toward the electrolyte filling port.

In addition, the first connection part may be directly connected to the first port.

In addition, the apparatus may further include a second connection part provided between the second port and the secondary battery manufacturing equipment to connect the second port and the secondary battery manufacturing equipment.

In addition, the first connection part may be indirectly connected to the first port via a separate first adapter.

In addition, the first adapter may be directly connected to the first connection part and may be directly connected to the first port, or is directly connected to the first connection part and is indirectly connected to the first port via a pipe fitting.

In addition, the second port may be indirectly connected to the secondary battery manufacturing equipment via a second adapter.

In addition, the second adapter may be directly connected to the second port or indirectly connected to the second port via a pipe fitting.

In addition, the first adapter and the second adapter may be integrated into a single body.

In addition, the second adapter may be directly connected to the secondary battery manufacturing equipment.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, an electrolyte filling port of a secondary battery is kept sealed under normal conditions to prevent the entry of moisture or foreign substances, and is automatically opened only when necessary, thereby reducing maintenance and management costs associated with sealing the electrolyte filling port during the manufacturing process of a secondary battery, simplifying the process, and enhancing productivity.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a side view schematically showing a sealing valve apparatus for a secondary battery filling port, according to an embodiment of the present disclosure, installed on an electrolyte filling port and in fluid communication with the battery manufacturing equipment;

FIG. 2 is a cross-sectional view showing the configuration and structure of a fluid valve part of a sealing valve apparatus for a secondary battery filling port according to an embodiment of the present disclosure;

FIG. 3 is an operational view showing a state in which the fluid valve part of FIG. 2 is opened;

FIG. 4 is a side view schematically showing a sealing valve apparatus for a secondary battery filling port, according to an embodiment of the present disclosure, installed on the electrolyte filling port;

FIG. 5 is a schematic view showing a sealing valve apparatus for a secondary battery filling port according to another embodiment of the present disclosure; and

FIG. 6 is a schematic view showing a sealing valve apparatus for a secondary battery filling port according to still another embodiment of the present disclosure.

### DETAILED DESCRIPTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

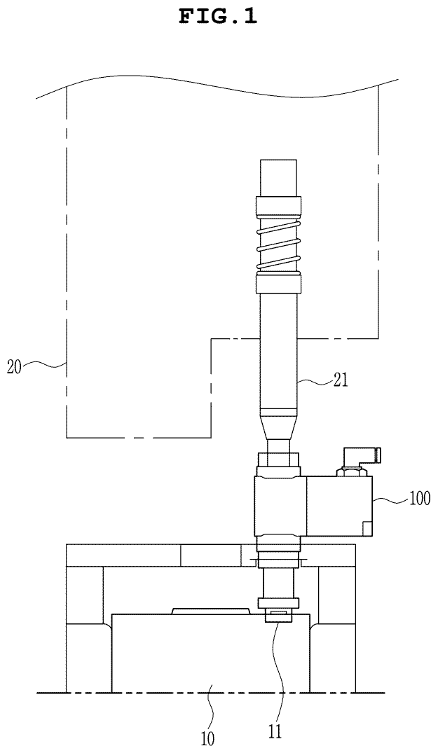

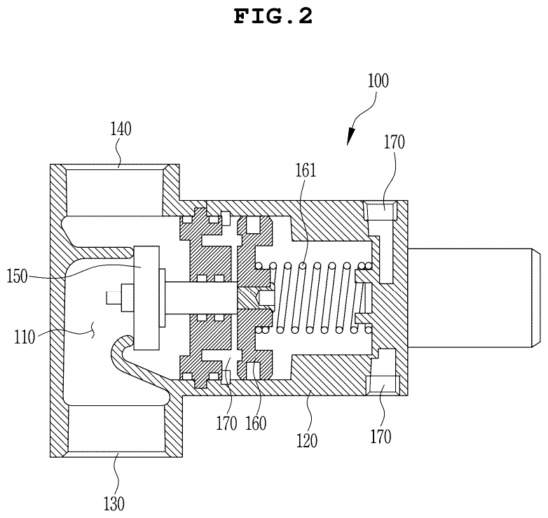

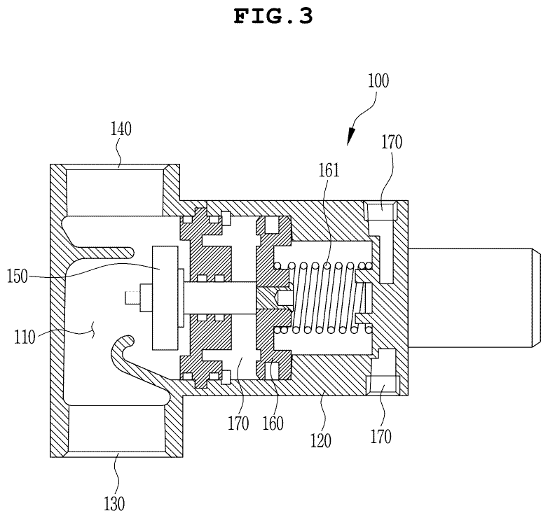

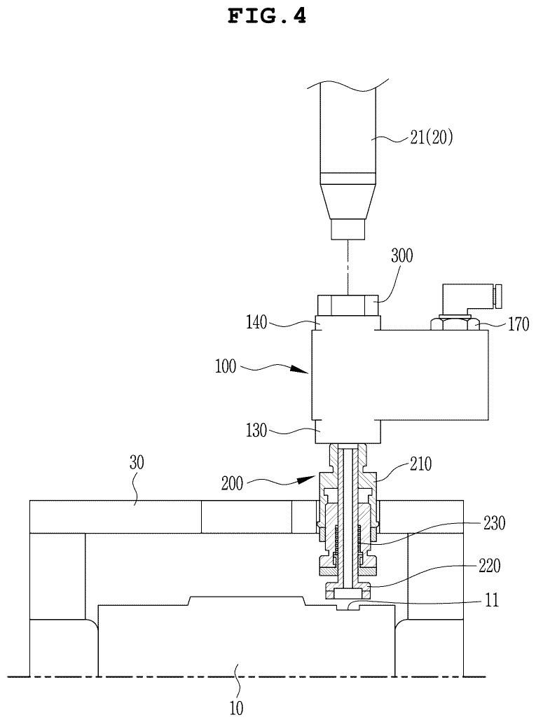

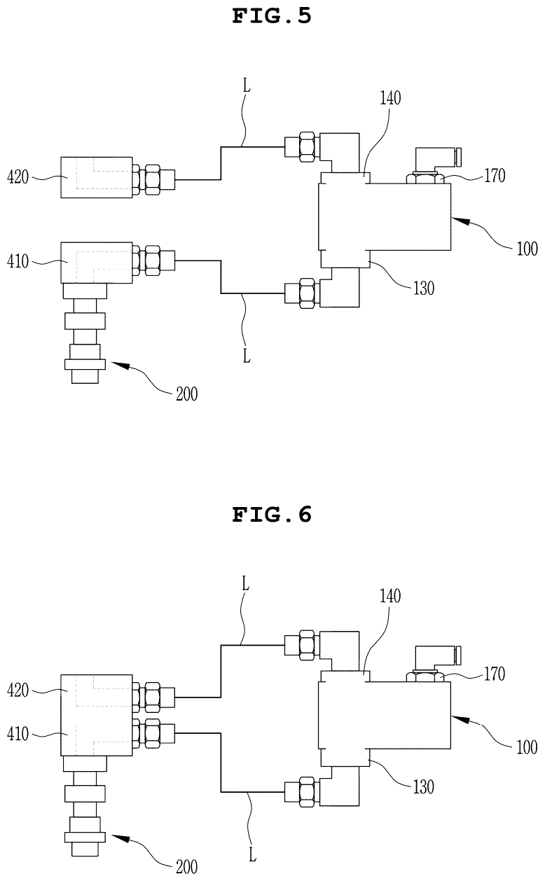

FIG. 1 is a side view schematically showing a sealing valve apparatus for a secondary battery filling port, according to an embodiment of the present disclosure, installed on an electrolyte filling port and in fluid communication with the battery manufacturing equipment; FIG. 2 is a cross-sectional view showing the configuration and structure of a fluid valve part of a sealing valve apparatus for a secondary battery filling port according to an embodiment of the present disclosure; FIG. 3 is an operational view showing a state in which the fluid valve part of FIG. 2 is opened; FIG. 4 is a side view schematically showing a sealing valve apparatus for a secondary battery filling port, according to an embodiment of the present disclosure, installed on the electrolyte filling port; FIG. 5 is a schematic view showing a sealing valve apparatus for a secondary battery filling port according to another embodiment of the present disclosure; and FIG. 6 is a schematic view showing a sealing valve apparatus for a secondary battery filling port according to still another embodiment of the present disclosure.

A sealing valve apparatus for a secondary battery filling port according to an embodiment of the present disclosure may include a fluid valve part 100 having one side connected to an electrolyte filling port 11 of a secondary battery 10 and the other side connected to secondary battery manufacturing equipment 20, in which an electrolyte filling flow path 110 is formed therein to provide communication between the one side and the other side, and which opens the electrolyte filling flow path 110 by externally supplied pressure to connect the electrolyte filling port 11 and the secondary battery manufacturing equipment 20 so as to be in fluid communication with each other.

According to an embodiment of the present disclosure, the apparatus is provided at the electrolyte filling port 11 of the secondary battery 10 to normally maintain the electrolyte filling port 11 in a sealed state, thereby preventing external moisture or foreign substances from entering the electrolyte filling port 11, and is connected to the secondary battery manufacturing equipment 20 to automatically open the electrolyte filling port 11 only when opening of the electrolyte filling port 11 is required.

As shown in FIG. 1, the fluid valve part 100 may be an element for connecting the electrolyte filling port 11 of the secondary battery 10 and the secondary battery manufacturing equipment 20 so that the electrolyte filling port 11 and the secondary battery manufacturing equipment 20 are in communication with each other through a flow path. As used herein, the term “communication” refers to a state in which elements are connected to each other along a path through which a fluid flows.

One side of the fluid valve part 100 may be in communication with the electrolyte filling port 11, and the other side may be in communication with a portion 21 of the secondary battery manufacturing equipment 20. In this case, the portion 21 of the secondary battery manufacturing equipment 20 that is in communication with the other side of the fluid valve part 100 may be, for example, a vacuum hopper or a filling nozzle.

For reference, when the vacuum hopper of the secondary battery manufacturing equipment 20 is in communication with the electrolyte filling port 11 via the fluid valve part 100, gas inside the secondary battery 10 may be discharged to the secondary battery manufacturing equipment 20 through the fluid valve part 100.

In addition, when the filling nozzle of the secondary battery manufacturing equipment 20 is in communication with the electrolyte filling port 11 via the fluid valve part 100, an electrolyte may be injected into the secondary battery 10 through the fluid valve part 100 and the electrolyte filling port 11.

One side of the fluid valve part 100 may be directly connected to the electrolyte filling port 11, unlike as shown in FIG. 1, or, as illustrated in FIG. 1, may be indirectly connected via another configuration (a first connection part) described below.

In addition, the other side of the fluid valve part 100 may also be directly connected to the secondary battery manufacturing equipment 20, or may be indirectly connected via another configuration (a second connection part), which can be appropriately selected and applied according to the needs of the implementer.

As shown in FIG. 2, the electrolyte filling flow path 110 communicating between the one side and the other side may be formed inside the fluid valve part 100. The electrolyte filling flow path 110 may be configured to be selectively opened by a pressure supplied from outside (hereinafter referred to as “external pressure”), and when the electrolyte filling flow path 110 is opened, the electrolyte filling port 11 and the secondary battery manufacturing equipment 20 are in communication, allowing gas inside the secondary battery 10 to be discharged to the outside or electrolyte to be injected into the secondary battery 10.

For reference, since external pressure is not supplied during normal operation, the electrolyte filling flow path 110 of the fluid valve part 100 remains closed, and the electrolyte filling port 11 communicating with one side of the fluid valve part 100 also remains sealed. The electrolyte filling flow path 110 and the electrolyte filling port 11 open only when the other side of the fluid valve part 100 is in communication with the secondary battery manufacturing equipment 20 and external pressure is applied.

To be specific, the fluid valve part 100 may include: a body part 120 in which the electrolyte filling flow path 110 is formed; a first port 130 provided at one side of the electrolyte filling flow path 110 so as to be connectable to the electrolyte filling port 11; a second port 140 provided at the other side of the electrolyte filling flow path 110 so as to be connectable to the secondary battery manufacturing equipment 20; and an on/off valve 150 movably provided within the body part 120 to selectively open and close the electrolyte filling flow path 110.

Referring to FIG. 2, the body part 120 may be an element constituting the overall exterior of the fluid valve part 100, and the electrolyte filling flow path 110 through which gas or electrolyte can pass may be formed therein.

The first port 130 is an element provided at one side of the electrolyte filling flow path 110 and may be formed in a manner connectable to the electrolyte filling port 11 either directly or indirectly. The first port 130 may be configured to communicate directly with the electrolyte filling port 11 depending on the shape or structure thereof. In addition, the first port 130 may communicate indirectly with the electrolyte filling port 11 via a separate configuration. The separate configuration that enables the first port 130 to communicate indirectly with the electrolyte filling port 11 will be described later.

The second port 140 is an element provided at the other side of the electrolyte filling flow path 110 and may be formed in a manner connectable to the secondary battery manufacturing equipment 20 either directly or indirectly. The second port 140 may also be configured to communicate directly with the secondary battery manufacturing equipment 20 or to communicate indirectly via a separate configuration. The separate configuration that enables the second port 140 to communicate indirectly with the secondary battery manufacturing equipment 20 will be described later.

The on/off valve 150 is an element provided to selectively open or close the electrolyte filling flow path 110 and may be movably installed within the body part 120. Depending on the movement of the on/off valve 150, the electrolyte filling flow path 110 may be closed or opened. When the electrolyte filling flow path 110 is closed by the on/off valve 150, fluid cannot flow through the electrolyte filling flow path 110, and thus the electrolyte filling port 11 connected to the first port 130 is in a sealed state. When the electrolyte filling flow path 110 is opened, the electrolyte filling port 11 may also be in an open state.

The on/off valve 150 may be moved within the body part 120 to open or close a specific section of the electrolyte filling flow path 110. Accordingly, the on/off valve 150 may provide a function that allows or prevents gas or electrolyte from passing through the flow path 110. Operation of the on/off valve 150 may be performed by an external force.

The fluid valve part 100 may further include: a piston part 160 connected to the on/off valve 150 and configured to actuate the on/off valve 150 by moving under pressure; and a pressure applying part 170 formed in the body part 120 to provide pressure to the piston part 160.

As shown in FIG. 3, the piston part 160 may be connected to the on/off valve 150 through a mechanical relationship (e.g., a piston rod). The piston part 160 may move within the body part 120 under external pressure, thereby actuating the on/off valve 150.

Thus, as exemplarily shown in FIG. 3, when pressure is applied to the left side of the piston part in the drawing due to the influence of external pressure (positive pressure), and the piston part 160 moves to the right, the on/off valve 150 moves in the same direction as the piston part 160, thereby opening the electrolyte filling flow path 110. A restoration spring 161 may be provided on one side of the piston part 160 to return the piston part 160 to the original position thereof when the external pressure is released. For reference, in case that the external pressure is static pressure, the restoration spring 161 may be disposed on the right side of the piston part 160 in the drawing, and when pressure is applied such that the piston part 160 moves to the right in the drawing, the restoration spring 161 may be compressed.

The pressure applying part 170 is configured to provide pressure to the piston part 160 and may be formed in the body part 120. The pressure applying part 170 may be connected to an external pressure supply source (not shown) to receive external pressure. In this case, the external pressure may be either positive pressure or negative pressure (vacuum pressure), and may be appropriately selected according to the needs of the implementor. For reference, the accompanying drawing of the present disclosure exemplarily illustrates a case in which positive pressure is provided.

The pressure applying part 170 may be configured such that a predetermined pressure passage is formed inside the body part 120, allowing external pressure to act on the piston part 160. Accordingly, the piston part 160 may move within the body part 120 by the external pressure applied to the pressure applying part 170, and through this interlinked operation, the on/off valve 150 may be moved together with the piston part 160 to open or close the electrolyte filling flow path 110.

Meanwhile, the sealing valve apparatus for a secondary battery filling port according to an embodiment of the present disclosure may further include: a first connection part 200 having one side connected to the first port 130 and the other side provided to be in contact with the electrolyte filling port 11.

As shown in FIG. 4, the fluid valve part 100 may be configured to communicate with the electrolyte filling port 11 via the first connection part 200. One side of the first connection part 200 may be in communication with the first port 130 of the fluid valve part 100, and the other side of the first connection part 200 may be formed to be in contact with the electrolyte filling port 11.

The first connection part 200 may be installed on a surrounding structure 30 configured to guide and fix the secondary battery 10. In this case, the other side of the first connection part 200 that comes into contact with the electrolyte filling port 11 may be made of a rubber material such as ethylene propylene diene monomer (EPDM). EPDM is known for outstanding heat, chemical, and weather resistance and can be used for waterproof materials, gaskets, and the like, thereby ensuring airtightness with the electrolyte filling port 11.

To be specific, the first connection part 200 may include: a body 210; a nozzle 220 provided on the body 210 to be movable in the direction of the electrolyte filling port 11 so that a distal end of the nozzle comes into close contact with the electrolyte filling port 11; and an elastic member 230 that provides an elastic force to press the nozzle 220 toward the electrolyte filling port 11.

Referring to FIG. 4, the body 210 is an element constituting all or part of the exterior of the first connection part 200, and one side of the body 210 may be in communication with the first port 130 of the fluid valve part 100. In addition, the body 210 may be fixed to the surrounding structure 30 configured to guide and secure the secondary battery 10.

The nozzle 220 is an element that comes into close contact with the electrolyte filling port 11 and may be provided to be movable in the direction of the electrolyte filling port 11 on the body 210. When the nozzle 220 is in close contact with the electrolyte filling port 11, the nozzle 220 may communicate with the body 210, thereby connecting the first port 130 of the fluid valve part 100 to the electrolyte filling port 11.

The elastic member 230 may provide an elastic force to the nozzle 220 so that the nozzle 220 is pressed toward the electrolyte filling port 11. Thus, when the nozzle 220 comes into contact with the electrolyte filling port 11, the elastic member 230 applies a pressing force, ensuring that the nozzle 220 is tightly sealed against the electrolyte filling port 11, thereby maintaining a sealed state.

In this case, the first connection part 200 may be directly connected to the first port 130.

As shown in FIG. 4, an embodiment of the present disclosure is configured such that one side of the first connection part 200 is connected by being directly coupled to the first port 130 of the fluid valve part 100, allowing gas or electrolyte to be directly exchanged between the first connection part 200 and the fluid valve part 100.

In this case, the sealing valve apparatus for a secondary battery filling port according to an embodiment of the present disclosure may further include: a second connection part 300 provided between the second port 140 and the secondary battery manufacturing equipment 20 to connect the second port 140 and the secondary battery manufacturing equipment 20.

Referring to FIG. 4, the second port 140 of the fluid valve part 100 may be directly connected to the portion 21 of the secondary battery manufacturing equipment 20 (e.g., a vacuum hopper or a filling nozzle). However, when the diameter, shape, or structure of the second port 140 makes direct connection with the portion 21 of the secondary battery manufacturing equipment 20 impossible, the second port 140 may be configured to communicate with the portion 21 via the separate second connection part 300.

The second connection part 300 may be installed on the second port 140 and positioned between the second port 140 and the secondary battery manufacturing equipment 20. The second connection part 300 may be provided with a structure or shape capable of communicating with the portion 21 of the secondary battery manufacturing equipment 20, so that the second port 140 is connected to the portion 21 of the secondary battery manufacturing equipment 20 while maintaining airtightness.

Meanwhile, according to another embodiment of the present disclosure, the first connection part 200 may be indirectly connected to the first port 130 via a separate first adapter 410.

As previously described, the first connection part 200 may be directly connected to the first port 130 of the fluid valve part 100, but may also be indirectly connected to the first port 130 via the first adapter 410.

The first adapter 410 serves as an intermediate component disposed between the first connection part 200 and the first port 130, and a passage through which fluid can flow may be formed inside. In addition, ports may be respectively provided on opposite sides of the first adapter 410 to allow direct or indirect connection with the first connection part 200 and the first port 130.

As shown in FIG. 5, the first adapter 410 is directly connected to the first connection part 200 and may be directly connected to the first port 130 or indirectly connected via a pipe fitting L.

In other words, one side of the first connection part 200 is directly in communication with one side of the first adapter 410, and the other side of the first adapter 410 is either directly connected to the first port 130 of the fluid valve part 100 or indirectly connected to the first port 130 via the pipe fitting L such as a pipe or hose.

In this case, the second port 140 may be indirectly connected to the secondary battery manufacturing equipment 20 via a separate second adapter 420.

The second port 140 of the fluid valve part 100 may be directly connected to the secondary battery manufacturing equipment 20, but, as shown in FIG. 5, the second port 140 may also be indirectly connected via the separately provided second adapter 420.

The second adapter 420 serves as an intermediate component disposed between the secondary battery manufacturing equipment 20 and the second port 140, and a passage through which fluid can flow may be formed inside. In addition, ports may be respectively provided on opposite sides of the second adapter 420 to allow direct or indirect connection with the secondary battery manufacturing equipment 20 and the second port 140.

At this time, the second adapter 420 may be directly connected to the second port 140 or indirectly connected via a pipe fitting L.

The second adapter 420 may be directly connected to the second port 140 of the fluid valve part 100, or may be indirectly connected to the second port 140 via the pipe fitting L such as a pipe or hose.

In this case, as shown in FIG. 5, the first adapter 410 and the second adapter 420 may be formed as separate, independent components and configured to be disposed at different positions.

Meanwhile, according to another embodiment of the present disclosure, the first adapter 410 and the second adapter 420 may be integrated into a single body.

As shown in FIG. 6, the first adapter 410 and the second adapter 420 may be provided as an integrated structure forming a single body. When the first and second adapters 410 and 420 are provided as an integrated structure, the first adapter 410 may be positioned on the lower side of the single body, and the second adapter 420 may be positioned on the upper side of the single body.

Accordingly, the first connection part 200 is installed on the lower side of the first adapter 410 so as to be communicable, and the upper side of the second adapter 420 may communicate with the secondary battery manufacturing equipment 20. In addition, the first port 130 and the second port 140 of the fluid valve part 100 may be directly or indirectly connected to the first and second adapters 410 and 420, respectively, when provided as an integrated structure.

In this case, the second adapter 420 may be directly connected to the secondary battery manufacturing equipment 20.

Referring to FIGS. 5 and 6, the upper side of the second adapter 420, whether as a separate component or integrated with the first adapter 410, may be provided to directly communicate with the portion 21 of the secondary battery manufacturing equipment 20 (e.g., a vacuum hopper or a filling nozzle).

At this time, sine the internal diameter and structure of the port formed on one side (upper side) of the second adapter 420 may be manufactured in a form capable of directly connecting to the portion of the secondary battery manufacturing equipment 20, the second adapter 420 may be directly connected to the secondary battery manufacturing equipment 20 without using a separate component (e.g., the second connection part 300).

Meanwhile, in another embodiment, the second connection part 300 as described above may be provided on one side (upper side) of the second adapter 420. In this case, the second adapter 420 may be connected to the secondary battery manufacturing equipment 20 via the second connection part 300.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A sealing valve apparatus for a secondary battery filling port, the apparatus comprising:
a fluid valve part having a first side connected to an electrolyte filling port of a secondary battery and a second side connected to secondary battery manufacturing equipment, in which an electrolyte filling flow path is formed therein to provide communication between the first side and the second side, and configured to open the electrolyte filling flow path by externally supplied pressure to connect the electrolyte filling port and the secondary battery manufacturing equipment so as to be in fluid communication with each other.

2. The apparatus of claim 1, wherein the fluid valve part comprises:
a body part in which the electrolyte filling flow path is formed;
a first port provided at a first side of the electrolyte filling flow path so as to be connectable to the electrolyte filling port;
a second port provided at a second side of the electrolyte filling flow path so as to be connectable to the secondary battery manufacturing equipment; and
an on/off valve movably provided within the body part to selectively open and close the electrolyte filling flow path.

3. The apparatus of claim 2, wherein the fluid valve part further comprises:
a piston part connected to the on/off valve and configured to actuate the on/off valve by moving under pressure; and
a pressure applying part provided in the body part to provide pressure to the piston part.

4. The apparatus of claim 2, further comprising:
a first connection part having a first side connected to the first port and a second side provided to be in contact with the electrolyte filling port.

5. The apparatus of claim 4, wherein the first connection part comprises:
a body;
a nozzle provided on the body to be movable in a direction of the electrolyte filling port so that a distal end of the nozzle comes into close contact with the electrolyte filling port; and
an elastic member configured to provide an elastic force to press the nozzle toward the electrolyte filling port.

6. The apparatus of claim 4, wherein the first connection part is directly connected to the first port.

7. The apparatus of claim 6, further comprising:
a second connection part provided between the second port and the secondary battery manufacturing equipment to connect the second port and the secondary battery manufacturing equipment.

8. The apparatus of claim 4, wherein the first connection part is indirectly connected to the first port via a separate first adapter.

9. The apparatus of claim 8, wherein the first adapter is directly connected to the first connection part and is directly connected to the first port, or is directly connected to the first connection part and is indirectly connected to the first port via a pipe fitting.

10. The apparatus of claim 8, wherein the second port is indirectly connected to the secondary battery manufacturing equipment via a second adapter.

11. The apparatus of claim 10, wherein the second adapter is directly connected to the second port or indirectly connected to the second port via a pipe fitting.

12. The apparatus of claim 10, wherein the first adapter and the second adapter are integrated into a single body.

13. The apparatus of claim 10, wherein the second adapter is directly connected to the secondary battery manufacturing equipment.
